(19) United States
(12) Patent Application Publication
(10) Pub. No.: US 2008/0162531 A1
(43) Pub. Date: Jul. 3, 2008

(54) Object-Oriented Framework for Data-Analysis Having Pluggable Platform Runtimes and Export Services

(75) Inventor: Joshua S. van Eikeren, Bend, OR (US)

Correspondence Address: PAUL VAN EIKEREN;BLUE REFERENCE, INC., 2554 NW 1ST ST., BEND, OR, 97701, US

(73) Assignee: Blue Reference, Inc., Bend, OR (US)

(21) Appl. No.: 11/619,336

(22) Filed: Jan. 3, 2007

(51) Int. Cl. G06F 7/00

(52) U.S. Cl. 707/102

(57) ABSTRACT

An object-oriented framework for generating data analysis results using pluggable platform runtimes and data analysis results documents using pluggable export services is disclosed. The object-oriented framework is comprised of software interfaces and objects for facilitating the generation of data analysis results and data analysis results documents and the creation of new pluggable platform runtime and export service objects. Software programmers can create new computer program products as either standalone applications or plug-in modules for word processing applications that leverage the object-oriented framework to generate data analysis results and data analysis results documents.

### CROSS-REFERENCE TO RELATED APPLICATIONS

U.S. patent application Attorney Docket No. BLUEREF-001, filed on Jan. 3, 2007 and entitled “Method and Apparatus for Utilizing an Extensible Markup Language Data Structure For Defining a Data-Analysis Parts Container For Use in a Word Processor Application,” U.S. patent application Attorney Docket No. BLUEREF-002, filed on Jan. 3, 2007 and entitled “Method and Apparatus for Managing Data-Analysis Parts in a Word Processor Application,” and U.S. patent application Attorney Docket No. BLUEREF-004, filed on Jan. 3, 2007 and entitled “Method and Apparatus for Data Analysis in a Word Processor Application,” which are assigned to the same assignee as the present invention, are hereby incorporated, in their entirety, by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademarks Office patent or records, but otherwise reserves all copyright rights whatsoever.

### BACKGROUND

Data-analysis is a process involving the organization, examination, display, and analysis of collected data using narratives, figures, charts, graphs and tables. Data analyses are aided by data-analysis processors, which are computational engines, either in hardware or software, which can execute the data-analysis process. High-end data-analysis processor typically have a language component like the R, S, SAS, Mathlab®, Python, and Perl families of languages. The availability of a language component facilitates data-analysis in numerous ways including the following: arbitrary data transformations; applying one analysis result to results form another; abstraction of repeated complex analysis steps; and development of new methodology.

A principal challenge of data-analysis processors is communicating the results of data-analysis to data owners. Generation of reports as part of a data-analysis project typically employs two separate steps. First, the data are analyzed using a data-analysis application based on a data-analysis processor. And two, data-analysis results (tables, graphs, figures) are used as the basis for a report document using a word processor application. Although, many data-analysis applications try to support this process by generating pre-formatted tables, graphs and figures that can be easily integrated into a report document using copy-and-paste from the data-analysis application to the word processing application, the basic paradigm is to construct the report document around the results obtained from data-analysis.

Another approach for integration of data-analysis and report document generation is to embed the data-analysis itself into the report document. The concept of “literate programming systems”, “literate statistical practice” and “literate data-analysis” are big efforts in this area. Proponents of this approach advocate software systems for authoring and distributing these dynamic data-analysis documents that contain text, code, data, and any auxiliary content needed to recreate the computations. The documents are dynamic in that the contents, including figures, tables, etc., can be recalculated each time a view of the document is generated. The advantage of this integration is that it allows readers to both verify and adapt the data-analysis process outlined in the document. A user can readily reproduce the data-analysis at any time in the future and a user can present the data-analysis results in a different medium.

Whatever the precise merits and features of the prior art in this field, the earlier art does not achieve or fulfill the purposes of the present invention. The prior art does not provide for the following:
the capability of providing a programmable object model for allowing a user/programmer to easily facilitate data-analysis from within new software applications;
the capability of providing a programmable object model for allowing a user/programmer to easily facilitate data-analysis from within existing software applications, such as a word processor application;
the capability of providing a programmable object model for allowing a user/programmer to easily create and utilize new data processors (or “platform runtimes” for generating a data-analysis results collection; and
the capability of providing a programmable object model for allowing a user/programmer to easily create and utilize new export services for generating at least one data-analysis results document;

Accordingly, a need exists for an object-oriented framework that supports the creation of computer-implemented applications, methods and systems that enable users to generate a data-analysis results collection and at least one data-analysis results document using new software applications or familiar existing software applications like a word processor application.

### SUMMARY

In accordance with the present invention, the above and other problems are solved by providing the following:
an object-oriented framework for generating a data-analysis results collection (using pluggable platform runtimes) and at least one data-analysis results document (using pluggable export services);
a method for employing the framework to generate a data-analysis results collection;
a computer program product that employs the framework to generate a data-analysis results collection;
a computer program product that employs the framework and a word processor application plus plug-in module to a data-analysis results collection;
a method for employing the framework to generate at least one data-analysis results document;
a computer program product that employs the framework to generate at least one data-analysis results document; and
a computer program product that employs the framework and a word processor application plus plug-in module to generate at least one data-analysis results document.

The object-oriented framework comprises a collection of software objects and interfaces that facilitate the following activities:
generating a data-analysis results collection;
generating at least one data-analysis results document;
generating a list of installed platform runtimes;
generating a list of installed export services;
creating a new platform runtime as the combination of an XML document (comprising the properties of the new platform runtime) and a collection of software objects that implement existing framework interfaces and leverage existing framework objects to provide data-analysis functionality; and
creating a new export service as the combination of an XML document (comprising the properties of the new export service) and a collection of software objects that implement existing framework interfaces and leverage existing framework objects to generate a data-analysis results document;

In accordance with the present invention, a method is provided that employs the object-oriented framework to generate a data-analysis results collection. This method entails instantiating a data-analysis parts container object (comprising a property identifying a platform runtime for the data-analysis parts container); reading the platform runtime property of the data-analysis parts container; instantiating a platform runtime object associated with the platform runtime property; and finally communicating the data-analysis parts container object to the platform runtime object. This method results in the generation of a data-analysis results object.

In addition, a computer program product is also provided that employs the object-oriented framework to generate a data-analysis results collection. This computer program product comprises a data-analysis parts container object (comprising a property identifying a platform runtime); a platform runtime associated with the platform runtime property; and an object from the object-oriented framework for instantiating the platform runtime object for generating a data-analysis results collection.

Moreover, a computer program product is additionally provided that employs the object-oriented framework and a word processor application to generate a data-analysis results collection. This computer program product comprises a word processor application; a data-analysis template comprising a data-analysis template comprising a word processor document and a data-analysis parts container; and a plug-in module for use in the word processor application which facilitates data-analysis on the data-analysis template using the object-oriented framework.

In accordance with the present invention, a method is provided that employs the object-oriented framework to generate at least one data-analysis results document. This method entails instantiating a data-analysis template object comprising a word processor document object and a data-analysis parts container object; instantiating a data-analysis results object; specifying an export service; instantiating an export service object (associated with the specified export service); and communicating the data-analysis template and the data-analysis results object to the export service object. This method results in the generation of a data-analysis results document object.

In addition, a computer program product is also provided that employs the object-oriented framework to generate at least one data-analysis results document. This computer program product comprises a data-analysis template comprising a word processor document object and a data-analysis parts container object; a data-analysis results object comprising a data-analysis results collection generated using the data-analysis parts container object; a specified export service; an export service object (associated with the specified export service) for generating a data-analysis results document; and an object from the object-oriented framework that communicates the data-analysis template object and the data-analysis results object to the export service object to generate a data-analysis result document.

Finally, a computer program product is additionally provided that employs an object-oriented framework for data-analysis and a word processor application to generate at least one data-analysis results document. This computer program product comprises a word processor application, a data-analysis template comprising a word processor document and a data-analysis parts container, and a plug-in module for use in the word processor application for generating a data-analysis results document using the object-oriented framework.

### BRIEF DESCRIPTION OF THE DRAWINGS

FIG. 1 is a block diagram of a computing apparatus that may operate in one exemplary embodiment of the present invention.

FIG. 2 is a block diagram of the object-oriented framework.

FIG. 3 is a block diagram of the elements of the method for generating a data-analysis results collection in accordance with the claims.

FIG. 4 is a block diagram of the object hierarchies within the object-oriented framework.

FIG. 5 is a block diagram of a computer program product for generating a data-analysis results collection.

FIG. 6 is a block diagram of a word processor application plug-in software module for facilitating the generation of a data-analysis results collection and at least one data-analysis results document.

FIG. 7 is a block diagram of the elements of the method for generating a data-analysis results document in accordance with the claims.

FIG. 8 is a block diagram of a computer program product for generating at least one data-analysis results document.

FIG. 9 is a source code listing of a runtime object.

FIG. 10 is a source code listing of a runtime info object.

FIG. 11 is a source code listing of a runtime engine object.

FIG. 12 is a source code listing of a runtime evaluator object.

DEFINITION LIST

| Term | Definition |
|---|---|
| object-oriented framework | As used herein, the term “object-oriented framework” is a set |
| | of libraries or classes that are used to implement the |
| | standard structure of an application for a specific operating |
| | system. Such a framework consists of abstract and concrete |
| | classes. |
| software object | As used herein, the term “software object” (or “object”) is a |
| | principal building block in object-oriented design or |
| | programming. It refers to a computer-readable concrete |
| | realization, an instance, of a class that consists of data and |
| | the operations associated with that data. |
| abstract interface | As used herein, the term “abstract interface” is a computer- |
| | readable software object that contains only the signatures of |
| | methods, delegates or events. The implementation of the |
| | methods is done in the class that implements the interface. |
| data-analysis template | As used herein, the term “data-analysis template” refers to a |
| | computer-readable data structure comprising a word |
| | processor document and a data-analysis parts container, |
| | where the template may serve as a master or pattern for the |
| | generation of a data-analysis results collection and/or a |
| | data-analysis results document. data-analysis templates |
| | allow the data-analysis results collection and the data- |
| | analysis results document to have content which is structured |
| | and formatted in standardized and recognizable ways. |
| data-analysis results | As used herein, the term “data-analysis results” refers to the |
| | output generated by the data-analysis processor as a result |
| | of communicating a data-analysis parts container to a data- |
| | analysis processor. Data-analysis results may take many |
| | forms, including but not limited to the following: objects, |
| | binary files, text files, graphic files and data sets. |
| data-analysis results document | As used herein, the term “data-analysis results document” |
| | refers to a word processor document generated as a result of |
| | communicating a data-analysis template and data-analysis |
| | results to an export service, where the template serves as a |
| | master or pattern for the data-analysis results document. The |
| | resulting data-analysis results document has content which is |
| | structured and formatted in standardized and recognizable |
| | ways. |
| data-analysis parts container | As used herein, the term “data-analysis part container” refers |
| | to a computer-readable container entity, such as an object |
| | that holds other objects, for holding one or more data- |
| | analysis parts. |
| platform runtime | The term “platform runtime” (or “data-analysis processor”) |
| | refers to a computational engine for performing data- |
| | analysis on a data-analysis container for generating a data- |
| | analysis results collection. A platform runtime may comprise |
| | a dynamic programming language, a library of methods, or a |
| | runtime with an application programming interface. |
| XML document | As used herein, the term “XML document” (or extensible |
| | markup language document”) refers to a computer-readable |
| | document that comprises general-purpose markup language |
| | that supports a wide variety of applications and facilitates the |
| | sharing of data across different information systems. |
| pluggable | As used herein, the term “pluggable” refers to an architecture |
| | where components are based on abstract classes, and |
| | because these components maintain the same interface, they |
| | can be easily substituted. |
| data-analysis | As used herein, the term “data-analysis” refers to the process |
| | of collecting, organizing, examining, displaying and |
| | analyzing collected data using narratives, charts, figures, |
| | graphs and tables. Data-analysis might include the |
| | following: processing data in order to draw inferences and |
| | conclusions; systematically applying statistical and logical |
| | techniques to describe, summarize, and compare data; and |
| | systematically studying the data so that its meaning, |
| | structure, relationships, origins and other properties are |
| | understood. |
| data-analysis part | As used herein, the term “data-analysis part” refers to a |
| | computer-readable component entity involved in data- |
| | analysis including but not limited to the following: data sets, |
| | formulas, algorithms, models, code blocks, expressions, code |
| | libraries, scripts, instructions, software objects, files, dynamic |
| | and static libraries, packages, statistical components, |
| | simulation components, graphing components, database |
| | components, files, and records. |
| word processor application | As used herein, the term “word processor application” refers |
| | to a computer application operative to provide functionality |
| | for creating, displaying, editing, formatting and printing |
| | electronic documents. |
| word processor document | As used herein, the term “word processor document” refers |
| | to a computer-readable document object entity, which may |
| | be structured as a document object model. A document is |
| | instantiated in a word processor application and may be |
| | serialized, for example, to a web page for viewing, to a disk |
| | for storage as a file or to a printer for hard copy. |
| plug-in software module | As used herein, the term “plug-in software module” is a |
| | computer program that interacts with a main application to |
| | provide a certain, usually very specific, function. The main |
| | application provides services which the plug-ins can use, |
| | including a way for plug-ins to register themselves with the |
| | main application and a protocol by which data is exchanged |
| | with plug-ins. Plug-ins are dependent on these services |
| | provided by the main application and do not usually work by |
| | themselves. Conversely, the main application is independent |
| | of the plug-ins, making it possible for plug-ins to be added |
| | and updated dynamically without changes to the main |
| | application. |
| smart document solution | As used herein, the term “smart document solution” refers to |
| | a collection of Microsoft technologies, which employ XML and |
| | programmatic customization to provide context sensitive |
| | information in Microsoft Office documents within the |
| | standard product interface. |
| Microsoft Word Add-In | As used herein, the term “Microsoft Word Add-In” refers to a |
| | collection of Microsoft technologies, which employ XML and |
| | programmatic customization to provide additional |
| | functionality within the Microsoft Office standard product |
| | interface. |
| export service | As used herein, the term “export service” refers to a |
| | document engine that combines a data-analysis template |
| | with a data-analysis results collection to generate a data- |
| | analysis results document. |
| application programming | As used herein, the term “application programming interface” |
| interface | (or “API”) is a source code interface that a computer system or |
| | program library provides in order to support requests for |
| | services to be made of it by a computer program. |
| code block | As used herein, the term “code block” refers to a logical |
| | grouping of computer-readable instructions comprising one |
| | or more lines of programming code, which may be contained |
| | in a data-analysis parts container and which may be executed |
| | by a data-analysis processor. |

### DETAILED DESCRIPTION

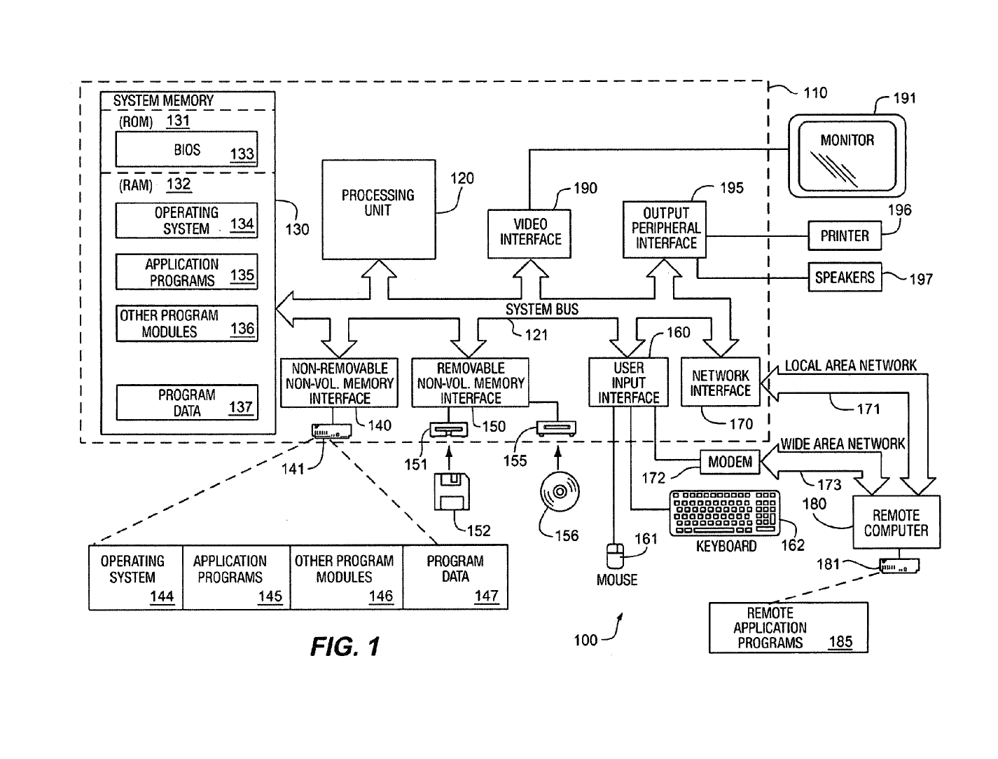

Referring now to the drawings, in which like numerals represent like elements through several figures, aspects of the present invention and the exemplary operating environment will be described. FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, and other computer instructions or components that perform particular tasks or implement particular abstract data types. The methods and apparatus may also be practiced in distributed computing environments where tasks are performed by remote processing devices that are linked through a communications network, such as web services. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates the following: operating system 134, such as the WINDOWS XP operating system from Microsoft Corporation of Redmond, Wash.; application programs 135, such as the word processor Word developed by Microsoft Corporation; other program modules 136, such as data-analysis processors including R from the R-PROJECT, S-Plus from INSIGHTFUL CORPORATION, PYTHON from the PYTHON SOFTWARE FOUNDATION, MATLAB from MATHWORKS CORPORATION, and PERL from the PERL FOUNDATION; and program data 137, such as a data-analysis template comprising a word processor document, for example in the form of a WORD word processor program document and a data-analysis parts container. It should further be appreciated that the various aspects of the present invention are not limited to word processing applications programs but may also utilize other application programs 135 which are capable of processing data-analysis parts, such as spreadsheet (e.g., EXCEL spreadsheet program from MICROSOFT CORPORATION) and presentation (e.g., POWERPOINT presentation program from MICROSOFT CORPORATION) application programs.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

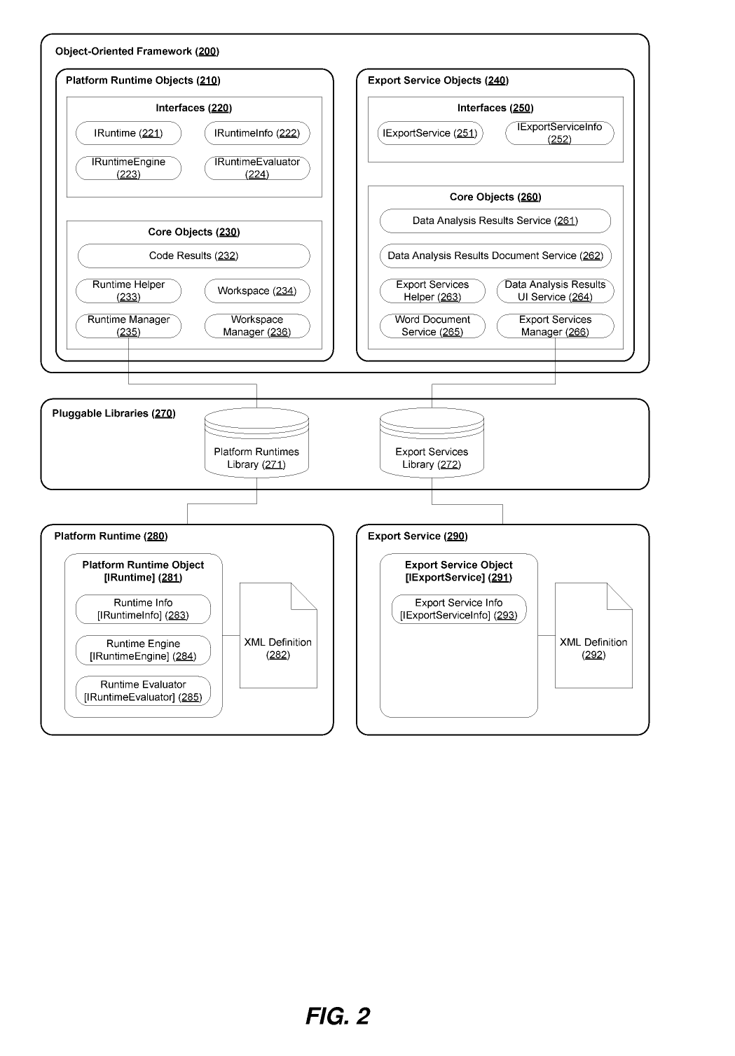

FIG. 2 is an illustration of an exemplary object-oriented framework for facilitating the generation of a data-analysis results collection (using pluggable platform runtimes) and the generation of at least one data-analysis results document (using pluggable export services) in accordance with the claims of the present invention. It should be appreciated that although the embodiments of the invention described herein are presented in the context of the word processor application Word developed by Microsoft Corporation, the invention may be utilized within other application programs including but not limited to other word processing application programs such as StarOffice Writer developed by Sun Microsystems Corporation (also distributed as the Open Source project Open Office), spreadsheet application programs such as Excel developed by Microsoft Corporation, presentation application programs such as PowerPoint developed by Microsoft Corporation, drawing application programs such as Visio developed by Microsoft Corporation, or database application programs such as Access developed by Microsoft Corporation.

A software framework is a defined support structure in which another software project can be organized and developed. A framework may include support programs, code libraries, a scripting language, or other software to help develop and glue together the different components of a software project. Frameworks are designed with the intent of facilitating software development, by allowing designers and programmers to spend more time on meeting software requirements rather than dealing with the more tedious low level details of providing a working system. By bundling a large amount of reusable code into a framework, much time is saved for the developer, since he/she is saved the task of rewriting large amounts of standard code for each new application that is developed. Application frameworks are especially useful when implementing graphical user interface (GUI), since these tended to promote a standard structure for applications. It is also much simpler to create automatic GUI creation tools when a standard framework is used, since the underlying code structure of the application is known in advance. Object-oriented programming techniques are preferably used to implement frameworks such that the unique parts of an application can simply inherit from pre-existing classes in the framework; such frameworks are referred to as “object-oriented frameworks.”

Those skilled in the art will recognize that object-oriented frameworks are items of commerce. For example, one of the first commercial frameworks was MacApp, written by Apple Computer for the Macintosh. Microsoft has developed frameworks for its Windows application development beginning with the Microsoft Foundation Classes (MFC) for Visual C++ to the most recent .NET programming platform for Microsoft Visual Studio.

Referring now to FIG. 2, the exemplary object-oriented framework 200 is comprised of two collections of objects: platform runtime objects 210 (used to facilitate the generation of a data-analysis results collection) and export service objects 240 (used to facilitate the generation of at least one data-analysis results document). The platform runtime objects 210 further comprise two sub-collections of objects: interfaces 220 (abstract interfaces used to define pluggable objects that generate a data-analysis results collection) and core objects 230 (software objects that can be leveraged to create either new custom pluggable platform runtimes that plug into the object-oriented framework or new custom software applications that generate, use, or communicate data-analysis results). The export services objects 240 further comprise two sub-collections of objects: interfaces 250 (abstract interfaces used to define pluggable objects that generate at least one data-analysis results document) and core objects 260 (software objects that can be leveraged to create either new custom pluggable export services that plug into the object-oriented framework or new custom software applications that generate, use, or communicate at least one data-analysis results document).

According to a preferred embodiment of the invention, the platform runtimes (data-analysis processors) are represented by pluggable program modules. This allows a programmer to add and to remove different platform runtimes to the object-oriented framework for data analysis. In this way the object-oriented framework and the platform runtimes may be universally adapted to different kinds of data-analysis requirements.

In one embodiment of the invention, pluggable platform runtimes are constructed for data-analysis processors including but not limited to the following: R developed by R-Project for Statistical Computing; Python developed by Python Foundation; and IronPython developed by Microsoft Corporation. In another embodiment of the invention, data-analysis processors include the following: S-Plus™ processor developed by Insightful Corporation; MATLAB™ processor developed by MathWorks Corporation; Perl processor developed by Perl Foundation; SAS™ processor developed by SAS Institute Corporation; Mathematica™ processor developed by Wolfram Research Corporation; Octave processor developed by the University of Wisconsin; F# processor developed by Microsoft Corporation; Haskell processor developed by the Yale Haskell group; and Ruby processor developed by Gardens Point.

According to a preferred embodiment of the invention, the export services are represented by pluggable program modules. This allows a programmer to add and to remove different export services to the object-oriented framework for data analysis. In this way the object-oriented framework and the export services may be universally adapted to different kinds of data-analysis requirements.

In one embodiment of the invention, pluggable export services are constructed for the file export formats including: single file web page (*.mht, *.mhtml); web page (*.htm, *.html); and binary Word (*.doc). In another embodiment of the invention, the file export formats include but are not limited to the following: portable document format (*.pdf); XML paper specification format (*.xps); extensible markup language file (*.xml); rich text format (*.rtf); plain text (*.txt); Word markup language (*.docx); Word markup language macro-enabled document (*.docm); and TeX format (*.tex).

It should be appreciated by those skilled in the art that while embodiments of the exemplary object-oriented framework illustrated in FIG. 2 are implemented as a collection of C# software objects developed using the Microsoft NET platform, it is recognized that the object-oriented framework could be implemented in any object-oriented software development platform, including such development platforms as: NET (C#, VB.NET, C++, J#) developed by Microsoft Corporation, Visual Basic developed by Microsoft Corporation, Visual C++ developed by Microsoft Corporation, Visual J++ developed by Microsoft Corporation, and Java developed by Sun Corporation.

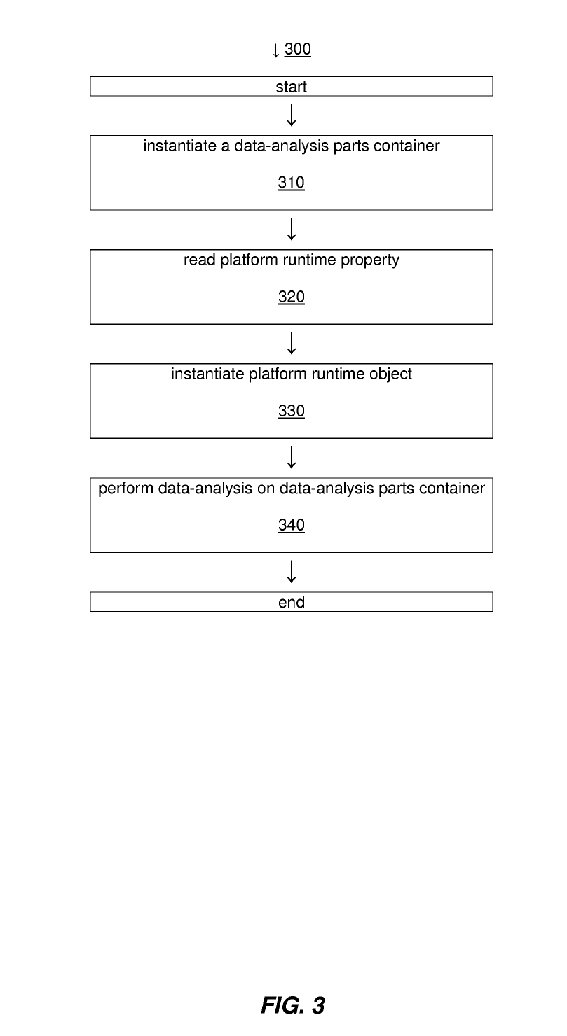

FIG. 3 is an illustration of a routine of steps that may be performed in accordance with the present invention to generate a data-analysis results collection. When reading the discussion of the routines presented herein, it should be appreciated that the logical operations of the various embodiments of the present invention are implemented as (1) computer-executable instructions, such as program modules, being executed by a computer and/or (2) as interconnected machine logic circuits or circuit modules within the computing system. The implementation is a matter of choice dependent on performance requirements of the computing system implementing the invention. Accordingly, the logical operation illustrated in FIG. 3, and making up an embodiments of the present invention described herein are referred to variously as operations, structural devices, acts or program modules. It will be recognized by one skilled in the art that these operations, structural devices, acts and modules may be implemented in software, firmware, in special purpose digital logic, and any combination thereof without deviating from the spirit and scope of the present invention as recited within the claims set forth herein.

Referring now to FIG. 3, the routine 300 starts at operation 310, wherein the method entails instantiating a data-analysis parts container object. This object may be instantiated by creating a new empty object or by reading serialized data from an XML-formatted string or XML-formatted file. The object may be further modified by using the exposed application programming interface (API) of the object to change its properties or modify its contents. Operation 310 continues to operation 320, which entails reading the platform runtime property of the data-analysis parts container object; this property is exposed by the objects API and indicates a string “key” identifying the platform runtime associated with the data-analysis parts container and its contents. Operation 330 entails instantiating the platform runtime object that matches the platform runtime property identified in operation 320. Operation 330 continues to operation 340, which entails communicating the data-analysis part container object instantiated in operation 310 to the platform runtime object instantiated in operation 330 to generate a data-analysis results object. It is recognized by those skilled in the art that operation 340 may entail a series of subroutines, wherein the communication process may involve the creation of additional objects and additional method calls on those objects.

Within operation 320, the platform runtime property identifies the platform runtime associated with the data-analysis parts container from the platform runtimes library 271, which contains the collection of installed platform runtimes. Each platform runtime 280 is comprised of a platform runtime object 281 and an XML document 282 that defines one or more properties of the platform runtime. Such properties may include the string key associated with the platform runtime and an additional string that identifies the software object that comprises the platform runtime. The string that identifies the software object is used within objects of the object-oriented framework to dynamically instantiate platform runtime objects. It is also contemplated that NET reflection may be used in place of the XML document 282 to define an installed platform runtime. The object-oriented framework also contains an object runtime manager 235, which may be used to create a list of the available pluggable platform runtimes installed.

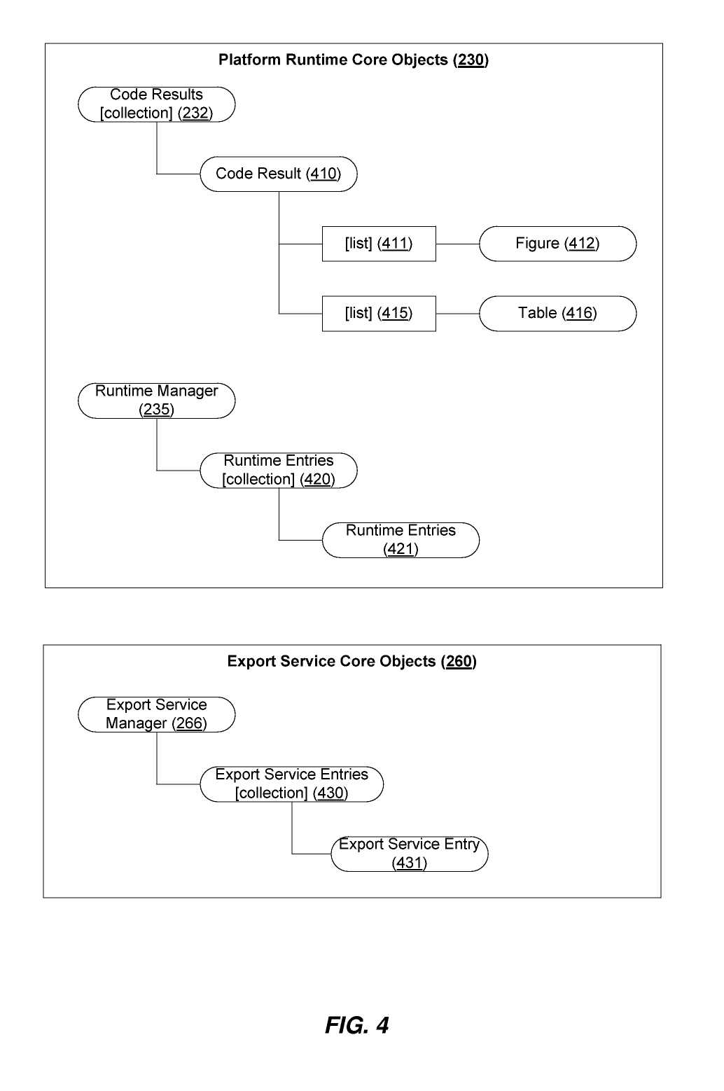

FIG. 4 is an illustration of additional exemplary object hierarchies that comprise the platform runtime core objects 230 and export service core objects 260 within the object-oriented framework 200. The runtime manager object 235 comprises a runtime entries object 420, which itself comprises a collection of runtime entry 421 objects. Each runtime entry object 421 records the properties necessary to instantiate the required platform runtime objects for use in the pluggable system; these properties are read from the XML document 282.

Within operation 330, the instantiated platform runtime object 281 implements the interface IRuntime 221. The instantiated platform runtime object of operation 330 is further comprised of sub-objects that provide additional functionality. The first sub-object is the runtime info object 283 that defines one or more properties of the platform runtime; this object implements the interface IRuntimeinfo 222. The second sub-object is the runtime engine object 284 that performs data-analysis on an entire data-analysis parts container; this object implements the interface IRuntimeEngine 223. The third sub-object is the runtime evaluator object 285 that performs data-analysis on a portion of a data-analysis part; this object implements the interface IRuntimeEvaluator 224. These interfaces are used to ensure that all pluggable platform runtime objects created for use within the object-oriented framework conform to specific application programming interface contracts, such that the objects can operate interchangeably.

In another embodiment of the invention, additional objects contained in the object-oriented framework may also be leveraged within the implementation of the platform runtime object of operation 330. Such objects include runtime helper 233 (an object containing a collection of subroutines useful in creating new pluggable platform runtimes), workspace 234 (an object that provides a virtual workspace where temporary files can be written and collected), workspace manager 236 (an object that manages the collection of workspace 234 objects created by the system), and code results 232 (an object that assists with the recording and collection of data-analysis result objects).

Referring to FIG. 4, the code results object 232 comprises a collection of code result objects 410. The code result object 410 stores text, figure, and table output resulting from code execution. The object itself comprises a list 411 of figure objects 412 and a list 412 of table objects 416. The figure object 412 records a path to a figure graphics file; the table object 416 records a path to a structured table file. In one embodiment of the present invention, figure graphics files and structured table files are contained within a folder identified in a workspace 234 object. It is contemplated that both the figure object 412 and the table object 416 may record additional properties beyond file paths.

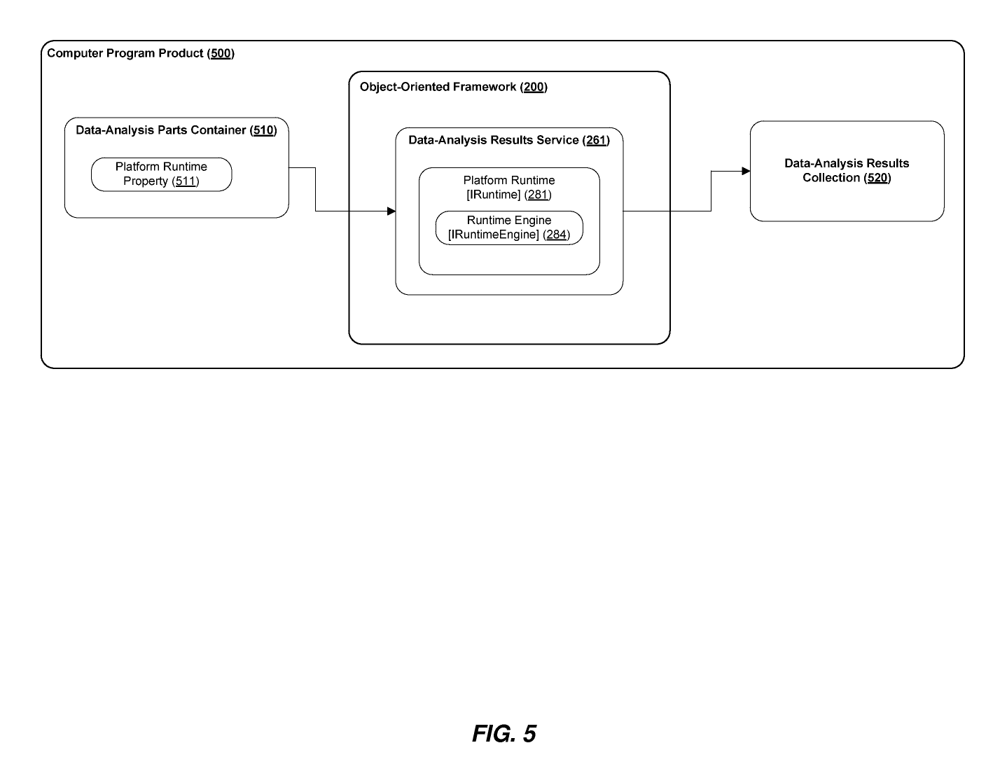

FIG. 5 is an illustration of a computer program product 500 that generates a data-analysis results collection 520 using the object-oriented framework 200. The product contains a data-analysis parts container 510, which in turn contains a platform runtime property 511 that identifies the platform runtime 280 associated with the data-analysis parts container. The product leverages the data-analysis results service object 261 contained in the object-oriented framework 200. This object instantiates the appropriate platform runtime object 281 based upon the platform runtime property 511 of the data-analysis parts container 510. The platform runtime object 281 employs a runtime engine object 284 to generate the data-analysis results object 520, using the data-analysis parts container 510 as an input.

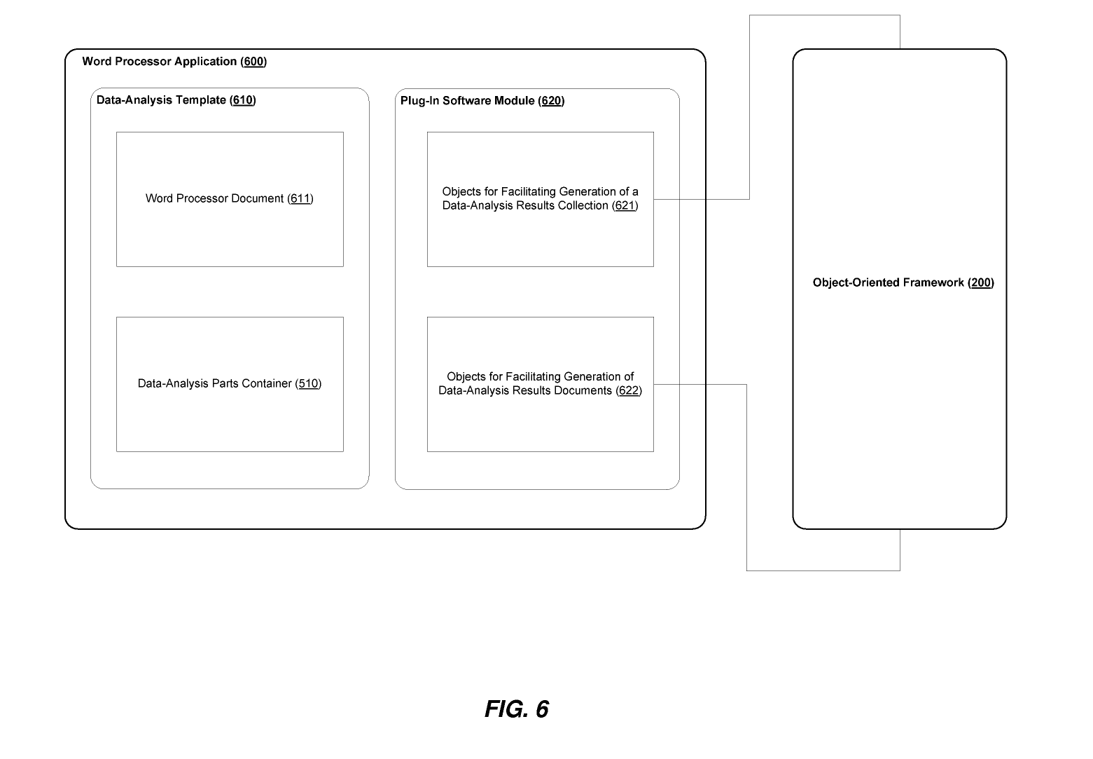

FIG. 6 is an illustration of a computer implemented solution that employs a word processor application 600 to facilitate data-analysis. The word processor application 600 contains a data-analysis template 610, comprising a word processor document 611 and a data-analysis parts container 510. The word processor application 600 also includes a plug-in software module 620 that facilitates data-analysis on the contained data-analysis parts container. The plug-in software module 620 contains two groups of objects. The first group comprises objects that facilitate the generation of a data-analysis results collection 621; these objects employ and leverage additional objects from the object-oriented framework 200. The second group comprises objects that facilitate the generation of at least one data-analysis results document; these objects employ and leverage additional objects from the object-oriented framework 200. Further details on the means by which a data-analysis parts container may be embedded into a word processor document and the means by which a plug-in software module can be created for a word processor application are described in co-pending U.S. patent application entitled “Method and Apparatus for Data Analysis in a Word Processor Application,” the disclosure of which is incorporated herein, in its entirety.

In one embodiment of the invention, the solution employs Word by Microsoft Corporation as the word processor application and a smart document solution as the plug-in software module. Smart document solutions allow programmatic customization of a word processor document or template, including writing code that executes in response to word processor events or custom user-interface additions.

In another embodiment of the invention, the solution may employ Word by Microsoft Corporation as the word process application and a Microsoft Word Add-In as the plug-in software module. Microsoft Word Add-In solutions allow the addition of custom functions to the application environment.

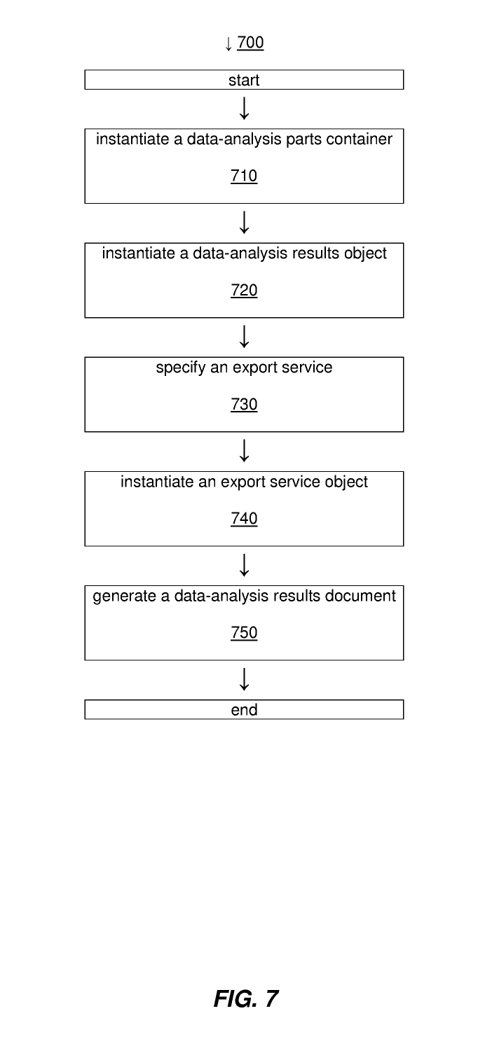

FIG. 7 is an illustration of a routine of steps that may be performed in accordance with the present invention to generate at least one data-analysis results document. The routine 700 starts at operation 710, wherein the method entails instantiating a data-analysis parts container object. This object may be instantiated by creating a new empty object or by reading serialized data from an XML-formatted string or XML-formatted file. The object may be further modified by using the exposed API of the object to change its properties or modify its contents. Operation 710 continues to operation 720, which entails instantiating a data-analysis results object. This object may be instantiated using the routine of steps illustrated in FIG. 3, or by the computer program product illustrated in FIG. 5. Operation 720 continues to operation 730, which entails specifying a desired export service; the desired export service may be identified using a string key or by an object. Operation 730 continues to operation 740, which entails instantiating the export service object associated with the export service specified in operation 730. Operation 740 continues to operation 750, which entails communicating the data-analysis part container object instantiated in operation 710 and the data-analysis results object instantiated in operation 720 to the export service object instantiated in operation 740 to generate a data-analysis results document. It is recognized by those skilled in the art that operation 750 may entail a series of subroutines, wherein the communication process may involve the creation of additional objects and additional method calls on those objects.

Within operation 730, the desired export service is specified from the export services library 272, which contains the collection of installed export services. Each export service 290 is comprised of an export service object 291 and an XML document 292 that defines one or more properties of the export service. Such properties may include the string key associated with the export service and an additional string that identifies the software object that comprises the export service. The string that identifies the software object is used within objects of the object-oriented framework to dynamically instantiate export service objects. In another embodiment of the invention, .NET reflection may be used in place of the XML document 292 to define an installed export service. The object-oriented framework also contains on object export services manager 266, which may be used to create a list of the available pluggable export services installed.

Referring again to FIG. 4, the export services manager object 266 comprises an export service entries object 430, which itself comprises a collection of export service entry 431 objects. Each export service object 431 records the properties necessary to instantiate the required export service objects for use in the pluggable system; these properties are read from the XML document 292.

Within operation 740, the instantiated export service object 291 implements the interface IExportService 251. The instantiated export service object of operation 330 is further comprised of a sub-object export service info object 293 that defines one or more properties of the export service; this object implements the interface IExportServiceInfo 252. These interfaces are used to ensure that all pluggable export service objects created for use within the object-oriented framework conform to specific application programming interface contracts, such that the objects can operate interchangeably.

Additional objects contained in the object-oriented framework may also be leveraged within the implementation of the export service object of operation 740. Such objects include export services helper 263 (an object containing a collection of subroutines useful in creating new pluggable export services), data-analysis results UI service 264 (an object providing consistent user-interface presentation for data-analysis results and error handling), and word document service 265 (an object encapsulating routines associated with the generation and modification of Microsoft Word documents).

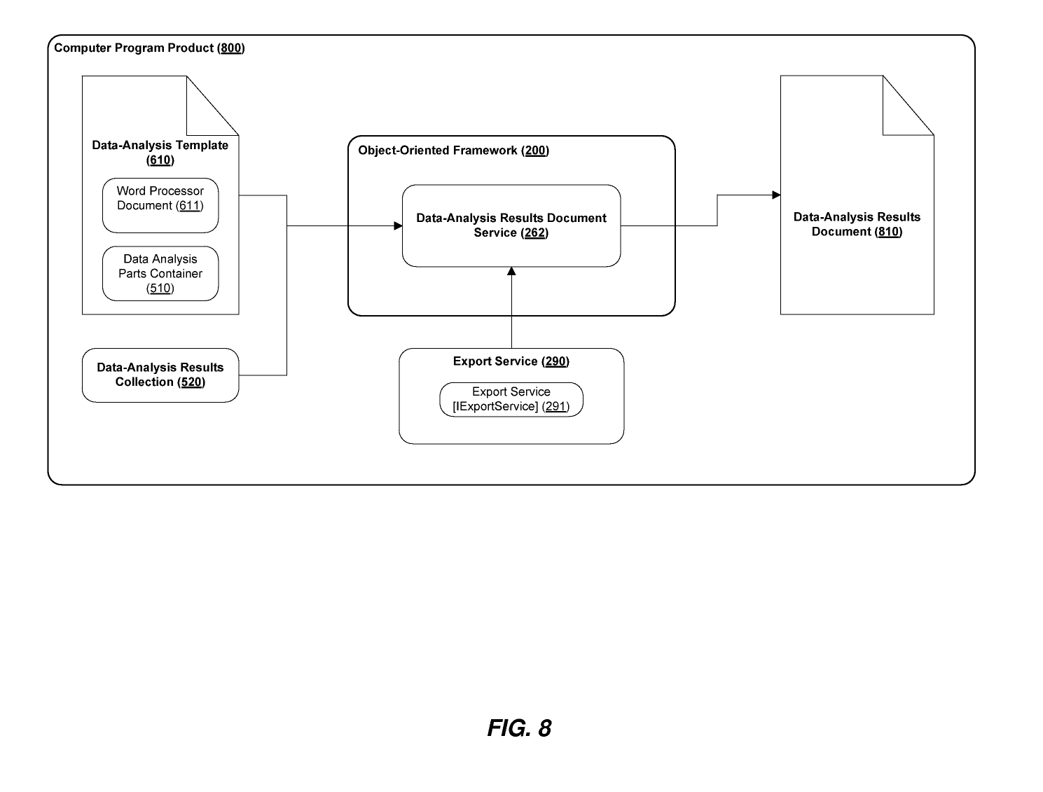

FIG. 8 is an illustration of a computer program product 800 that generates a data-analysis results document 810 using the object-oriented framework 200. The product contains a data-analysis template 610, comprising a word processor document 611 and a data-analysis parts container 510. The product leverages the data-analysis results document service object 262 contained in the object-oriented framework 200. This object communicates the data-analysis template 610 (comprising the word processor document 611 and the data-analysis parts container 510) and the data-analysis results collection 520 to the specified export service 290 (comprising an export service object 291) to generate the data-analysis results document 810.

The object-oriented framework consumes objects contained in the data-analysis parts container object model. Further details on the data-analysis parts container object model are described in co-pending U.S. patent application entitled “Method and Apparatus for Utilizing an Extensible Markup Language Data Structure to Define a Data-Analysis Parts Container for Use in a Word Processor Application,” the disclosure of which is incorporated herein, in its entirety.

The following is a description of objects and interfaces comprising application programming interfaces (API) that constitute the object-oriented framework. Following each of the objects set out below is a description of the operation, properties and methods of the object.
IRuntime Interface—This interface defines a platform runtime object.

The following are properties and methods of the object.
RuntimeInfo Property [Return Type IRuntimeinfo]—Returns the runtime info object for the platform runtime.
Initialize Method—Initializes the object with specified MatrixData and Workspace objects.
GetRuntimeEngine Method [Return Type IRuntimeEngine]—Returns the runtime engine object for the platform runtime.
GetRuntimeEvaluator Method [Return Type IRuntimeEvaluator]—Returns the runtime evaluator object for the platform runtime.

IRuntimeInfo Interface—This interface defines a runtime info object, which defines properties associated with the platform runtime.

The following are properties and methods of the object.
PlatformKey Property [Return Type String]—Returns the key string associated with the platform runtime.
CanDebug Property [Return Type Boolean]—Returns whether the platform runtime contains a runtime evaluator engine (used for line-by-line debugging).
EmbeddedObjectFileTypes Property [Return Type EmbeddedObjectFileTypes]—Returns a collection of allowable embedded object types supported by the platform runtime. Example types include *.r, *.rdata, *.python, and *.pickle files.
CreateReferencesList Method [Return Type ReferenceRoot]—Returns a root reference object (which itself may contain recursively defined child reference objects). A ReferenceRoot object encapsulates a reference to an outside library that can be imported and accessed within the platform runtime. Example R references include “cluster,” “grid,” and “lattice;” example Python references include “numeric,” “cPickle,” and “sys.”
CreateHelpProvider Method [Return Type IRuntimeHelpProvider]—Returns an object that provides general and context-sensitive help assistance.

IRuntimeEngine Interface—This interface defines a runtime engine object, used to perform data-analysis on an entire data-analysis parts container.

The following are properties and methods of the object.
ExecuteCodeBlocks Method [Return Type CodeResults]—Returns a CodeResults object comprising the data-analysis results collection generated from a specified data-analysis parts container.

IRuntimeEvaluator Interface—This interface defines a runtime evaluator object, used to perform data-analysis on a portion of a data-analysis part.

The following are properties and methods of the object.
LoadToReadyState Method—Loads up and initializes the evaluator.
PreProcessCodeBlock Method—Takes any actions necessary before processing a new code block.
PostProcessCodeBlock Method—Takes any actions necessary after processing a code block.
esetState Method—Resets the evaluator to its initial state and clears all previous execution results from memory.
Close Method—Closes down the evaluator and performs all necessary clean-up prior to object destruction.
Evaluate Method—Evaluates a specified string command.
EvaluateForOutput Method [Return Type CodeResult]—Evaluates a specified string command and returns a CodeResult object containing the evaluation output.

CodeResults Object—This object assists with the recording and collection of data-analysis result objects. This object extends CollectionBase and comprises a collection of CodeResult objects.

The following are properties and methods of the object.
Add Method [Return Type CodeResult]—Adds a new or specified CodeResult object to the internal collection.

AppendCodeResult Method [Return Type CodeResult]—Searches for a specified code result in the collection—if found, the contents of the specified code result are appended; otherwise, the specified code result is added to the internal collection.
Finditem Method [Return Type CodeResult]—Searches for a code result within the internal collection matching a specified GUID.

CodeResult Object—This object encapsulates the text, figure, and table output associated with executing a portion or the entirety of a code block or expression.

The following are properties and methods of the object.
GUID Property [Return Type String]—Returns the GUID of the code block or expression for which the code result object is associated with.
Description Property [Return Type String]—Returns a description of the code result.
OutputText Property [Return Type String]—Returns the text output associated with the code result.
Figures Property [Return Type List<Figure>]—Returns a structured list of Figure objects associated with the code result.
Tables Property [Return Type List<Table>]—Returns a structured list of Table objects associated with the code result.
HasOutput Property [Return Type Boolean]—Returns whether the code result as any text, figure, or table output.
HasOutputText Property [Return Type Boolean]—Returns whether the code result object has text output.
HasFigures Property [Return Type Boolean]—Returns whether the code result object has figure output.
HasTables Property [Return Type Boolean]—Returns whether the code result object has table output.
AppendCodeResult Method—Appends the contents of a specified code result object to this object.
AppendOutputLine Method—Appends a specified output string to the OutputText property of this object.
Clear Method—Initializes all properties to their initial values (empty strings and empty collections).

Figure Object—This object records a path to a figure graphics file.

The following are properties and methods of the object.
FilePath Property [Return Type String]—Returns the file path to the associated figure graphics file.
CopyToClipboard Method—Copies the figure graphics file to the Clipboard.

Table Object—This object records a path to a structured table file.

The following are properties and methods of the object.
FilePath Property [Return Type String]—Returns the file path to the associated structured table file.

RuntimeHelper Object—This object contains a collection of subroutines useful in creating new pluggable platform runtimes.

The following are properties and methods of the object.
GetCodeBlockindex Method [Return Type Int]—Returns the code block index from a specified output file name.

Workspace Object—This object provides a virtual workspace where temporary files can be written and collected.

The following are properties and methods of the object.
WorkspaceFolder Property [Return Type String]—Returns the folder path to the temporary workspace folder.
WorkspaceFolderInfo Property [Return Type FolderInfo]—Returns a FolderInfo object comprising properties for the associated temporary workspace folder.
DeleteAllWorkspaceFiles Method [Return Type Boolean]—Deletes all the files contained within the temporary workspace folder; returns true if successful.
DeleteWorkspaceFolder Method [Return Type Boolean]—Deletes the temporary workspace folder and all its contained files; returns true if successful.

WorkspaceManager Object—This object manages the collection of workspace objects created by the system.

The following are properties and methods of the object.
AddWorkspace Method—Adds a specified workspace to the internal collection.
DeleteAllWorkspaces Method—Deletes the contents of all workspaces and removes them from the internal collection.

RuntimeManager Object—This object create a list of the available pluggable platform runtimes installed. This object stores the list of available platform runtimes using an internal RuntimeEntities object.

The following are properties and methods of the object.
RuntimesList Property [Return Type List<IRuntimeInfo>]—Returns a structured list of runtime info objects for all the platform runtimes installed.
DefaultRuntime Property [Return Type IRuntimeInfo]—Returns the runtime info object for the default platform runtime selected by the user.
GetRuntimeOptions Method [Return Type RuntimeOptions]—Returns the user options associated with a specified platform runtime.
GetRuntimeRootPath Method [Return Type String]—Returns the folder path corresponding to the installation directory of a specified platform runtime.
GetRuntimesRootPath Method [Return Type String]—Returns the folder path corresponding to the root installation directory where platform runtimes are installed.
GetRuntimeInfo Method [Return Type IRuntimeInfo]—Returns the runtime info object associated with a specified platform runtime.
GetRuntime Method [Return Type IRuntime]—Returns the runtime object associated with a specified platform runtime.

RuntimeEntities Object—This object comprises the collection of available platform runtimes. This object extends CollectionBase and comprises a collection of RuntimeEntry objects.

The following are properties and methods of the object.
Add Method [Return Type RuntimeEntry]—Adds a specified runtime entry object to the internal collection.
Remove Method—Removes a specified runtime entry object from the internal collection.
Finditem Method [Return Type RuntimeEntry]—Returns a runtime entry object that matches a specified string key.
LoadRuntimeInfoObjects Method—Instantiates and records the appropriate runtime info object for each platform runtime in the internal collection.

RuntimeEntity Object—This object records the properties necessary to instantiate the required platform runtime objects for use in the pluggable system.

The following are properties and methods of the object.
Key Property [Return Type String]—Returns the key associated with the platform runtime (example: “BlueRef.R”).
AssemblyName Property [Return Type String]—Returns the name of the assembly containing the software objects comprising the platform runtime (example:

“BlueRef.Inference.Runtimes.R”).
RuntimeTypeName Property [Return Type String]—Returns the type name of the runtime object (the software object that implements IRuntime) for use with the platform runtime (example: “BlueRef.Inference.Runtimes.R.RRuntime”).
RuntimeInfoTypeName Property [Return Type String]—Returns the type name of the runtime info object (the software object that implements IRuntimeInfo) for use with the platform runtime (example:
“BlueRef.Inference.Runtimes.R.RRuntimeInfo”).

IExportService Interface—This interface defines an export service object.

The following are properties and methods of the object.
PrepareExport Method—Method to perform all pre-processing actions prior to export.
ExportDocument Method—Method to export the document.
IExportServiceInfo Interface—This interface defines properties associated with the export service.

The following are properties and methods of the object.
Name Property [Return Type String]—Returns the name of the export service.
Key Property [Return Type String]—Returns the key of the export service.

DataAnalysisResultsService—This object encapsulates a service to generate a data-analysis results collection.

The following are properties and methods of the object.
ExecuteCode Method [Return Type CodeResults]—Method to take a specified MatrixData object and Workspace object and return a CodeResults object containing the data-analysis results collection associated with the specified data-analysis parts container.
DataAnalysisResultsDocumentService—This object encapsulates a service to generate at least one data-analysis results document.

The following are properties and methods of the object.
ExecuteExportService Method—Method to execute an export service using a specified MatrixDocument object.

The export service can be specified by providing either an export service object (a software object that implements IExportService) or a string key of an export service. An existing CodeResults object can also be specified; if one is not specified, code results will be generated using the DataAnalysisResultsService object.

DataAnalysisResultsUIService—This object encapsulates a service to show a user-interface dialog presenting the data-analysis results document and/or data-analysis results, and any associated error messages.

The following are properties and methods of the object.
ShowDebugUI Method—Method to show a dialog presenting the data-analysis results document and/or data-analysis results to the user provided a specified Workspace object.

WordDocumentService—This object encapsulates a service to generate Microsoft Word documents from an existing template Word document.

The following are properties and methods of the object.
ExecuteWorkDocument Method—Method to combine a data-analysis template (a specified MatrixDocument object), an optional CodeResults object (generated if omitted), and a specified export format (Microsoft Word format, HTML format, MHT format, etc.) to generate a resulting Microsoft Word document at a specified file path.
ExportServicesManager Object—This object create a list of the available pluggable export services installed. This object stores the list of available export services using an internal ExportServiceEntities object.

The following are properties and methods of the object.
ExportServicesList Property [Return Type List<IExportServiceInfo>]—Returns a structured list of export service info objects for all the export services installed.
GetExportServiceRootPath Method [Return Type String]—Returns the folder path corresponding to the installation directory of a specified export service.
GetExportServicesRootPath Method [Return Type String]—Returns the folder path corresponding to the root installation directory where export services are installed.
GetExportServiceInfo Method [Return Type IExportServiceInfo]—Returns the export service info object associated with a specified export service.
GetExportService Method [Return Type IExportService]—Returns the export service object associated with a specified export service.

ExportServiceEntities Object—This object comprises the collection of available export services. This object extends CollectionBase and comprises a collection of ExportServiceEntry objects.

The following are properties and methods of the object.
Add Method [Return Type ExportServiceEntry]—Adds a specified export service entry object to the internal collection.
Remove Method—Removes a specified export service entry object from the internal collection.
Finditem Method [Return Type ExportServiceEntry]—Returns an export service entry object that matches a specified string key.
LoadRuntimeInfoObjects Method—Instantiates and records the appropriate export service info object for each export service in the internal collection.

ExportServiceEntry Object—This object records the properties necessary to instantiate the required export service objects for use in the pluggable system.

The following are properties and methods of the object.
Key Property [Return Type String]—Returns the key associated with the export service (example: “BlueRef.HTML”).
AssemblyName Property [Return Type String]—Returns the name of the assembly containing the software objects comprising the export service (example: “BlueRef.Inference.Export”).
ExportServiceTypeName Property [Return Type String]—Returns the type name of the export service object (the software object that implements IExportService) for use with the export service (example: “BlueRef.Inference.Export.HTMLExport”).
ExportServiceInfoTypeName Property [Return Type String]—Returns the type name of the export service info object (the software object that implements IExportServiceInfo) for use with the export service (example: “BlueRef.Inference.Export.HTMLExportinfo”).

The following code example illustrates how the object-oriented framework may be used to generate a data-analysis results collection from an existing file comprising a data-analysis parts container:

```
MatrixDocument myMatrixDocument =
    new MatrixDocument(“c:\\Temp\\Sample.matrix”);
Workspace myWorkspace = new Workspace( );
CodeResults myCodeResults =
    DataAnalysisResultsService.ExecuteCode(myMatrixDocument,
    myWorkspace, false);
```

The following code example illustrates how the object-oriented framework may be used to generate and present to the user a data-analysis result document (in HTML format) from an existing data-analysis template containing a data-analysis parts container:

```
MatrixWordDocument myMatrixWordDocument =
    new MatrixWordDocument(“c:\\Temp\\Sample.matrixword”);
IExportService htmlExportService = new HTMLExport( );
DataAnalysisResultsDocumentService.ExecuteExportService(
    myMatrixWordDocument, htmlExportService);
```

The following code example illustrates how the object-oriented framework may be used to list out the collection of installed platform runtimes:

foreach (IRuntimeInfo runtimeInfo in RuntimeManager.RuntimesList)
{
System.Diagnostics.Debug.WriteLine(runtimeInfo.PlatformKey);
}

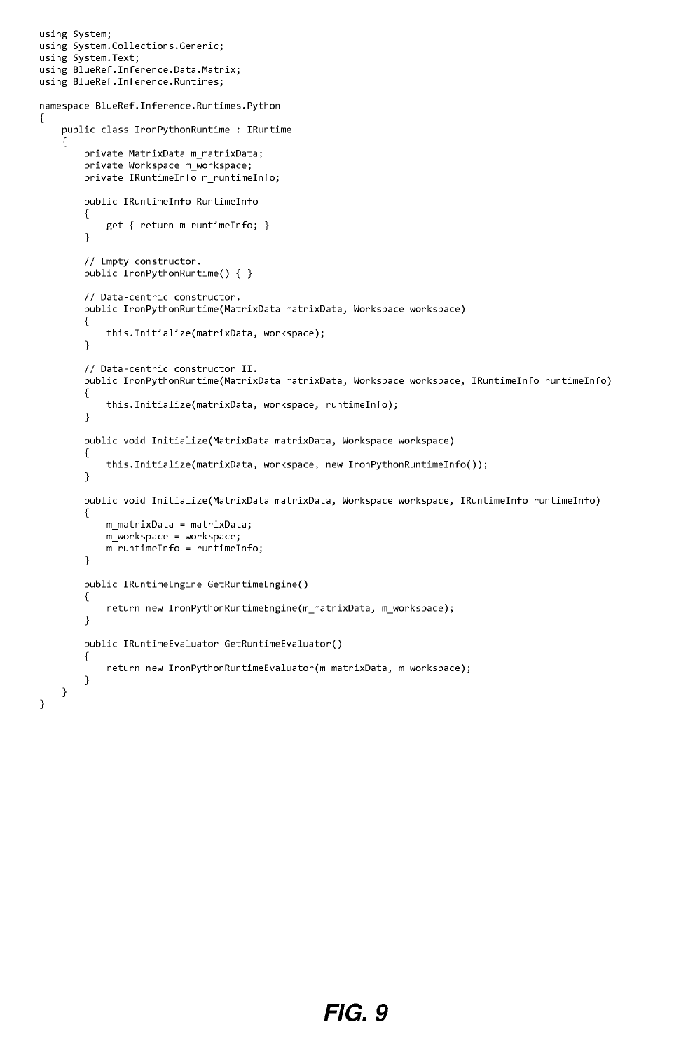

FIG. 9 depicts the source code for a sample embodiment of a pluggable platform runtime object IronPythonRuntime. This particular sample depicts the internal implementation of a platform runtime built to encapsulate the IronPython.NET scripting engine by Microsoft Corporation. The object implements the interface IRuntime 221 and comprises the additional objects IronPythonRuntimeInfo, IronPythonRuntimeEngine, and IronPythonRuntimeEvaluator.

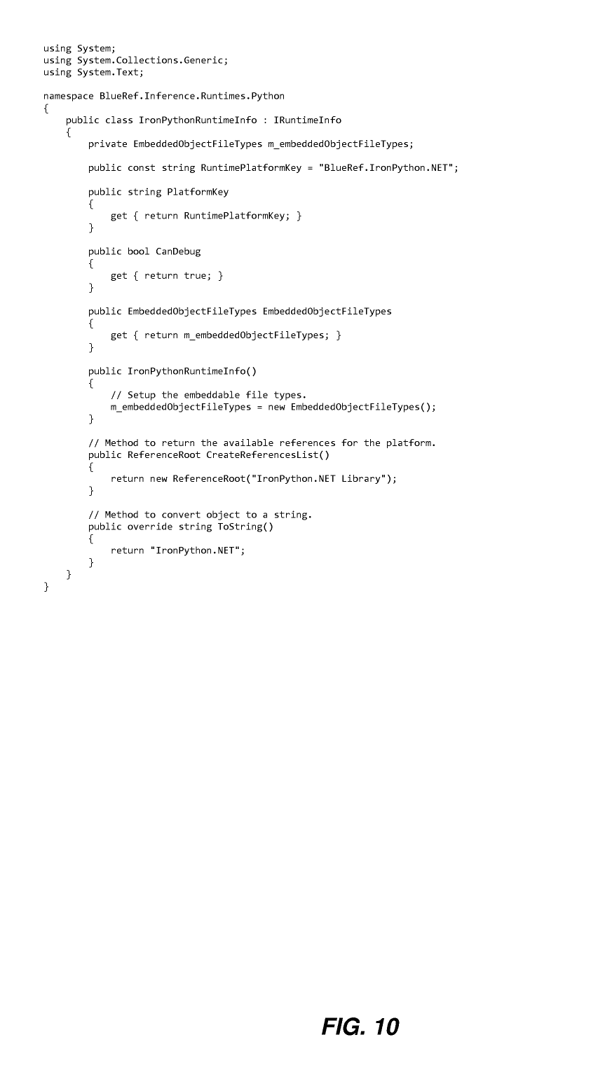

FIG. 10 depicts the source code for the corresponding sample runtime info object IronPythonRuntimeInfo, which implements the interface IRuntimeInfo 222.

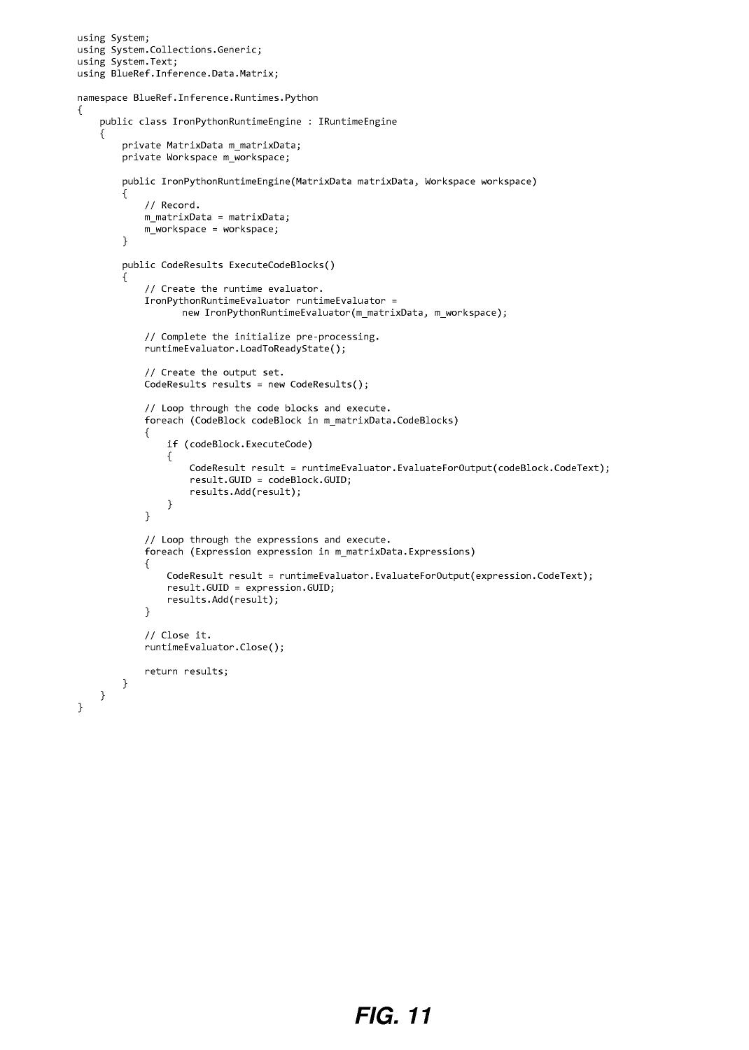

FIG. 11 depicts the source code for the corresponding sample runtime engine object IronPythonRuntimeEngine, which implements the interface IRuntimeEngine 223. This object employs an internal instance of an IronPythonEvaluator to evaluate code blocks and expressions to generate code results.

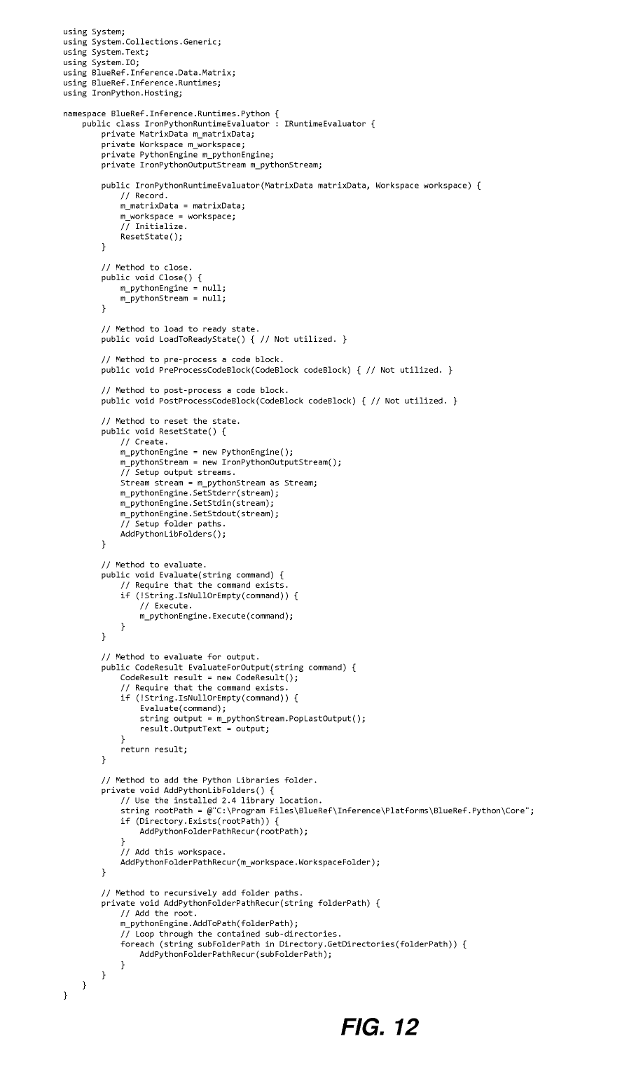

Finally, FIG. 12 depicts the corresponding sample runtime evaluator object IronPythonRuntimeEvaluator, which implements the interface IRuntimeEvaluator 224. This object employs the IronPython.NET scripting engine to evaluate a single command, producing a code result. The object also adds all existing python library paths to the IronPython.NET scripting engine's paths collection; this facilitates the use of additional python libraries from within code blocks and expressions.

Although the forgoing text sets forth a detailed description of numerous different embodiments, it should be understood that the scope of the patent is defined by the words in the claims set forth at the end of the patent. The detailed description is to be construed as exemplary only and does not describe every possible embodiment because describing every possible embodiment would be impractical, if not impossible. Numerous alternative embodiments could be implemented, using either current technology or technology developed after filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and not limiting upon the scope of the claims.

What is claimed is:

1. A computer readable medium with an object-oriented framework for data-analysis comprising:
one or more software objects for generating a data-analysis results collection;
one or more abstract interfaces for defining one or more software objects for generating a data-analysis results collection;
one or more software objects for generating a data-analysis results document; and
one or more abstract interfaces for defining one or more software objects for generating a data-analysis results document.

2. A computer-implemented method for generating a data-analysis results collection using a data-analysis parts container and an object-oriented framework for data-analysis comprising extension points for pluggable platform runtimes, the sequence of steps comprising:
instantiating a data-analysis parts container object corresponding to said data-analysis parts container, wherein the data-analysis parts container object comprises at least one platform runtime property identifying a platform runtime selected from a plurality of platform runtimes, wherein each platform runtime is pluggable within said object-oriented framework for data-analysis;
reading said platform runtime property of said data-analysis parts container object;
instantiating at least one platform runtime object corresponding to said platform runtime property; and communicating said data-analysis parts container object to said at least one platform runtime object for generation of a data-analysis results object,
whereby a data-analysis results collection is generated.

3. The method of claim 2, wherein the plurality of platform runtimes comprises:
R processor developed by R-Project for Statistical Computing;
S-Plus™ processor developed by Insightful Corporation;
MATLAB™ processor developed by MathWorks Corporation;
Python processor developed by Python Software Foundation;
IronPython processor developed by Microsoft Corporation;
Perl processor developed by Perl Foundation;
SAS™ processor developed by SAS Institute Corporation;
Mathematica™ processor developed by Wolfram Research Corporation;
Octave processor developed by the University of Wisconsin;
F# processor developed by Microsoft Corporation;
Haskell processor developed by the Yale Haskell group; and
Ruby processor developed by Gardens Point.

4. The method of claim 2, wherein each platform runtime comprises at least one XML document for defining one or more properties of the platform runtime.

5. The method of claim 2, wherein the object-oriented framework comprises at least one software object for generating a list of available pluggable platform runtime objects.

6. The method of claim 2, wherein each platform runtime object implements at least one abstract interface of the object-oriented framework.

7. The method of claim 2, wherein each platform runtime object comprises at least one software object for defining one or more properties of the platform runtime and implements at least one abstract interface of the object-oriented framework.

8. The method of claim 2, wherein each platform runtime object comprises at least one software object for performing data-analysis using a data-analysis parts container and implements at least one abstract interface of the object-oriented framework.

9. The method of claim 2, wherein each platform runtime object comprises at least one software object for evaluating at least one line of code from a data-analysis part of type code block and implements at least one abstract interface of the object-oriented framework.

10. The method of claim 2, wherein the object-oriented framework comprises at least one software object for construction of at least one pluggable platform runtime object.

11. A computer program product for generating a data-analysis result collection using a data-analysis parts container and an object-oriented framework for data-analysis comprising extension points for pluggable platform runtimes, the computer program product comprising a computer usable media, having computer program code thereon, comprising:
a means for instantiating a data-analysis parts container object corresponding to said data-analysis parts container, wherein the data-analysis parts container object comprises a platform runtime property identifying a platform runtime selected from a plurality of platform runtimes, wherein each platform runtime is pluggable within said object-oriented framework for data-analysis;
a platform runtime corresponding to said platform runtime property of said data-analysis parts container object; and
a means for instantiating at least one object from the object-oriented framework for instantiating the platform runtime object for generation of at least one data-analysis results object using said data-analysis parts container object.

12. The computer program product of claim 11, wherein the plurality of platform runtimes comprises:
R processor developed by R-Project for Statistical Computing;
S-Plus™ processor developed by Insightful Corporation;
MATLAB™ processor developed by MathWorks Corporation;
Python processor developed by Python Software Foundation;
IronPython processor developed by Microsoft Corporation;
Perl processor developed by Perl Foundation;
SAS™ processor developed by SAS Institute Corporation;
Mathematica™ processor developed by Wolfram Research Corporation;
Octave processor developed by the University of Wisconsin;
F# processor developed by Microsoft Corporation;
Haskell processor developed by the Yale Haskell group; and
Ruby processor developed by Gardens Point.

13. The computer program product of claim 11, wherein each platform runtime comprises at least one XML document for defining one or more properties of the platform runtime.

14. The computer program product of claim 11, wherein the object-oriented framework comprises at least one software object for generating a list of the available pluggable platform runtimes.

15. The computer program product of claim 11, wherein each platform runtime object implements at least one abstract interface of the object-oriented framework.

16. The computer program product of claim 11, wherein each platform runtime object comprises at least one software object for defining one or more properties of the platform runtime and implements at least one abstract interface of the object-oriented framework.

17. The computer program product of claim 11, wherein each platform runtime object comprises at least one software object for performing data-analysis using a data-analysis parts container and implements at least one abstract interface of the object-oriented framework.

18. The computer program product of claim 11, wherein each platform runtime object comprises at least one software object for evaluating at least one line of code from a data-analysis part of type code block and implements at least one abstract interface of the object-oriented framework.

19. The computer program product of claim 11, wherein the object-oriented framework comprises at least one software object for construction of at least one pluggable platform runtime object.

20. A computer program product for providing data-analysis in a word processor application using a data-analysis processor, the computer program product comprising a computer usable media, having computer program code thereon, comprising:
a data-analysis template comprising a word processor document and a data-analysis parts container;
an object-oriented framework for data-analysis; and
a plug-in software module for providing data-analysis on said data-analysis parts container using said object-oriented framework, a word processor application, and a data-analysis processor.

21. The computer program product of claim 20, wherein the word processor application comprises Microsoft Word and the plug-in software module comprises a smart document solution.

22. The computer program product of claim 20, wherein the word processor application comprises Microsoft Word and the plug-in software module comprises a Microsoft Word Add-In.

23. A computer-implemented method for generating a data-analysis results document using a data-analysis template and an object-oriented framework for data-analysis comprising extension points for pluggable export services, the method of steps comprising:
instantiating a data-analysis template object corresponding to said data-analysis template, wherein the data-analysis template object comprises a word processor document object and a data-analysis parts container object;
instantiating a data-analysis results object;
specifying an export service from a plurality of export services, wherein each export service is pluggable within said object-oriented framework for data-analysis;
instantiating an export service object, wherein the export service object corresponds to said export service; and
communicating the data-analysis template object and the data-analysis results object to said export service object,
whereby a data-analysis results document is generated.

24. The method of claim 23, wherein each export service comprises an XML document for defining one or more properties of the export service.

25. The method of claim 23, wherein the object-oriented framework comprises software objects for generating a list of available pluggable export services.

26. The method of claim 23, wherein the step of instantiating a data-analysis results object comprises the routine of steps outlined in FIG. 3.

27. The method of claim 23, wherein each export service object implements at least one abstract interface of the object-oriented framework.

28. The method of claim 23, wherein each export service object comprises at least one software object for defining one or more properties of the export service and implements at least one abstract interface of the object-oriented framework.

29. The method of claim 23, wherein the object-oriented framework comprises at least one software object for construction of at least one pluggable export service object.

30. A computer program product for generating a data-analysis results document using a data-analysis template and an object-oriented framework for data-analysis comprising extension points for pluggable export services, the computer program product comprising a computer usable media, having computer program code thereon, comprising:
a means for instantiating a data-analysis template object corresponding to said data-analysis template, wherein the data-analysis template object comprises a word processor document object and a data-analysis parts container object;
a means for instantiating a data-analysis results object, wherein the data-analysis results object comprises a data-analysis results collection generated using the data-analysis parts container;
an export service selected from a plurality of export services wherein each export service is pluggable within said object-oriented framework for data-analysis;
a means for instantiating an export service object corresponding to said export service for generating a data-analysis results document;
a means for instantiating a communications object from said object-oriented framework for communicating said data-analysis template object and said data-analysis results object to said export service object,
whereby a data-analysis results document is generated.

31. The computer program product of claim 30, wherein each export service comprises at least one XML document for defining one or more properties of the export service.

32. The computer program product of claim 30, wherein the object-oriented framework comprises at least one software object for generating a list of available pluggable export services.

33. The computer program product of claim 30, wherein the means for instantiating a data-analysis results object comprises the routine of steps outlined in FIG. 3.

34. The computer program product of claim 30, wherein each export service object implements at least one abstract interface of the object-oriented framework.

35. The computer program product of claim 30, wherein each export service object comprises at least one software object for defining one or more properties of the export service and implements at least one abstract interface of the object-oriented framework.

36. The computer program product of claim 30, wherein the object-oriented framework comprises at least one software object for construction of at least one pluggable export service object.

37. A computer program product for generating a data-analysis results document in a word processor application using a data-analysis processor, the computer program product comprising a computer usable media, having computer program code thereon, comprising:
a data-analysis template comprising a word processor document and a data-analysis parts container;
an object-oriented framework for data-analysis; and
a plug-in software module for generating a data-analysis results document using said data-analysis template, said object-oriented framework, a word processor application, and a data-analysis processor.

38. The computer program product of claim 37, wherein the word processor application comprises Microsoft Word and the plug-in software module comprises a smart document solution.

39. The computer program product of claim 37, wherein the word processor application comprises Microsoft Word and the plug-in software module comprises a Microsoft Word Add-In.
